(19) United States
(12) Patent Application Publication
(10) Pub. No.: US 2024/0021929 A1
(43) Pub. Date: Jan. 18, 2024

(54) METHOD OF MANUFACTURING POUCH, POUCH FOR SECONDARY BATTERY, AND POUCH-TYPE SECONDARY BATTERY

(71) Applicant: SK On Co., Ltd., Seoul (KR)

(72) Inventor: Joo Ho MOON, Daejeon (KR)

(21) Appl. No.: 18/309,526

(22) Filed: Apr. 28, 2023

(30) Foreign Application Priority Data
Jul. 14, 2022 (KR) 10-2022-0086788

(51) Int. Cl. H01M 50/129; H01M 50/105; H01M 50/131; H01M 50/186; H01M 50/121; H01M 50/119

(52) U.S. Cl. CPC H01M 50/129; H01M 50/105; H01M 50/131; H01M 50/186; H01M 50/121; H01M 50/119

(57) ABSTRACT

A method of manufacturing a pouch for a secondary battery, in which an accommodating portion for accommodating an electrode assembly is formed in a pouch film including an inner layer and an outer layer, is provided. The method includes forming an inner reinforcing layer on one surface of the inner layer, and stretching the pouch film by pressing the inner layer and the inner reinforcing layer, and the inner reinforcing layer includes at least one of polymers included in the inner layer. According to the pouch manufacturing method, a pouch for a secondary battery having excellent insulation resistance characteristics and substantially mitigating corrosion during a battery driving process may be provided with excellent productivity.

### CROSS REFERENCE TO RELATED APPLICATION(S)

This patent document claims the priority and benefits of Korean Patent Application No. 10-2022-0086788 filed on Jul. 14, 2022, the disclosure of which is incorporated herein by reference in its entirety.

### TECHNICAL FIELD

The technology and implementations disclosed in this patent document generally relate to a method of manufacturing a pouch, a pouch for a secondary battery, and a pouch-type secondary battery, and more particularly, to a method of manufacturing a pouch, for forming a space in which an electrode assembly is accommodated in a pouch film, a pouch for a secondary battery manufactured according to the method, and a pouch-type secondary battery including the same.

### BACKGROUND

Recently, as interest in environmental issues increase, demand for secondary batteries mainly used as power sources for electric vehicles (EVs) has been increasing. Secondary batteries are classified into pouch type batteries, cylindrical type batteries, prismatic type batteries, and the like, according to the type of exterior material used therefor. There among, the pouch-type secondary battery in which the electrode assembly is embedded in the accommodating portion of the pouch case has several advantages that manufacturing costs are inexpensive and it is easy to configure a high-capacity battery pack by connecting a plurality of unit cells in series and/or parallel, and thus research and development thereof are also being actively undertaken.

On the other hand, in order to manufacture a pouch for accommodating an electrode assembly in a pouch-type secondary battery, a process of forming an accommodating portion by stretching a pouch film through pressurization is mainly used (see FIGS. 1A and 1B). In general, high temperature and high pressure are applied to a pouch film 10 including an inner layer 1 and an outer layer 2 through a pressing device 0 to form an accommodating portion S in which the electrode assembly may be accommodated. The pressing device 0 is a device that applies high temperature and high pressure to the pouch film 10 through a hot-press method, and therefore, the pouch film 10 may be formed to manufacture a pouch 100 for a secondary battery including the accommodating portion S.

In this process, the inner layer 1 may be damaged due to the high temperature and high pressure applied to the pouch film 10. In order to alleviate this problem, the temperature and pressure set in the pressing device 0 may be lowered, but in this case, the process time for manufacturing the pouch increases, resulting in a decrease in productivity. Accordingly, there is a need for a method of manufacturing a pouch capable of manufacturing a pouch by mitigating damage to the pouch film and increasing productivity thereof.

### SUMMARY

The disclosed technology may be implemented in some embodiments to provide a method of manufacturing a pouch, in which damage to a pouch film may be substantially alleviated and productivity may also be excellent.

The disclosed technology may be implemented in some embodiments to provide a pouch for a secondary battery in which damage of a pouch film is alleviated, the thickness thereof is well maintained, and insulating properties and the like are excellent.

The disclosed technology may be implemented in some embodiments to provide a pouch-type secondary battery including a pouch for a secondary battery having excellent insulation properties and the like, and free from corrosion and the like during battery driving.

In some embodiments of the disclosed technology, a method of manufacturing a pouch for a secondary battery, in which an accommodating portion for accommodating an electrode assembly is formed in a pouch film including an inner layer and an outer layer, includes forming an inner reinforcing layer on one surface of the inner layer; and stretching the pouch film by pressing the inner layer and the inner reinforcing layer, and the inner reinforcing layer includes at least one of polymers included in the inner layer.

The polymer may be at least one selected from polypropylene (PP) and acid-modified polypropylene (PPa).

The inner reinforcing layer may be formed on area A, and the area A may be an area including a boundary line where the inner layer comes into contact with a pressing device.

A width (W_{A}) of the area A may be a sum of inner and outer distances vertically spaced based on a boundary line where a length portion of the pressing device comes into contact with the inner layer, and a value of the W_{A} may be to 10 cm.

A length (L_{A}) of the area A may be a sum of inner and outer distances spaced in a vertical direction based on a boundary line where a width portion of the pressing device comes into contact with the inner layer, and a value of the L_{A} may be 0.01 to 10 cm.

The forming of the inner reinforcing layer may be performed with a maximum height of the inner reinforcing layer of 0.01 to 1 mm/cm relative to a forming depth. The stretching of the pouch film may be performed at to 150° C.

The pouch for a secondary battery may include a sealant layer and a gas barrier layer, and an RS value according to Equation 1-1: R_{S}=T_{S_MIN}/T₀×100 may be 50% or more, where R_{S} is a side thickness retention rate (%), T_{S_MIN} is a minimum value of a sealant layer thickness (T_{S}) located on a side of the accommodating portion, and T₀ is the thickness of the inner layer.

In some embodiments of the disclosed technology, a pouch for a secondary battery, including an accommodating portion accommodating an electrode assembly therein, and a sealing portion, includes a sealant layer and a gas barrier layer. A minimum insulation resistance value of the sealant layer on the side of the accommodating portion is 100 MΩ or more.

An R_{SS} value according to Equation 2-1: R_{SS}=T_{S_MIN}/T_{1_MAX} may be 0.5 or more, where R_{SS} is a thickness ratio of the sealant layer located on the side of the accommodating portion and the sealing portion, T_{S_MIN} is a minimum value of a sealant layer thickness (T_{S}) located on the side of the accommodating portion, and T_{1_MAX} is a maximum value of a sealant layer thickness (Tₗ) located on the sealing portion.

An R_{SB} value according to Equation 3-1: R_{SB} T_{S_MIN}/T_{B_MIN} may be 0.5 to 1.5, where R_{SB} is a thickness ratio of the sealant layer located on the side and a bottom surface of the accommodating portion, T_{S_MIN} is a minimum value of the thickness of the sealant layer located on the side surface of the accommodating portion, and T_{B_MIN} is a minimum value of the thickness of the sealant layer located on the bottom surface of the accommodating portion.

The pouch for a secondary battery may be manufactured by the method of manufacturing a pouch described above.

In some embodiments of the disclosed technology, a pouch-type secondary battery includes the pouch for a secondary battery described above. The pouch for a secondary battery includes an electrode assembly in an accommodating portion, and the electrode assembly includes a positive electrode, a negative electrode, and a separator interposed therebetween.

The electrode assembly may have a jelly roll structure, a stack structure, a stack-folding structure, or a lamination-stack structure.

The positive electrode may include at least one selected from lithium-nickel-manganese oxide (LNMO), lithium-permanganese oxide (LMR), nickel-chromium-manganese oxide (NCM), and lithium-phosphate-iron oxide (LFP), as an active material.

The negative electrode may include at least one selected from a carbon-based material; a silicon-based material; at least one metal selected from Li, Sn, Zn, Mg, Cd, Ce, Ni and Fe; an alloy composed of the metal; an oxide of the metal; and a composite of the metal and carbon, as an active material.

### BRIEF DESCRIPTION OF DRAWINGS

Certain aspects, features, and advantages of the disclosed technology are illustrated by the following detailed description with reference to the accompanying drawings.

FIGS. 1A and 1B are conceptual views schematically illustrating, in sequence, an existing method of manufacturing a pouch in which an accommodating portion capable of accommodating an electrode assembly is formed by pressing a pouch film by a pressing device.

FIGS. 2A and 2B respectively are a plan view (FIG. 2A) and a perspective view (FIG. 2B) viewed from the top, conceptually illustrating the form in which area A is set on the inner layer of the pouch film, based on the boundary line where the inner layer contacts the pressing device.

FIG. 3A is a perspective view conceptually illustrating a pouch film in which an inner reinforcing layer is formed on area A according to an embodiment.

FIGS. 3B and 3C are conceptual views schematically sequentially illustrating a method of manufacturing a pouch according to an embodiment, in which an accommodating portion with a reinforced weak insulation portion is formed by pressing a pouch film in which an inner reinforcing layer is formed on area A.

FIGS. 4A and 4B illustrate a method of manufacturing a pouch, in which an accommodating portion with a reinforced insulating weak portion is formed by pressing a pouch film having an inner reinforcing layer formed on area A according to an embodiment, and is a conceptual diagram of schematically illustrating, in order, a method of manufacturing a pouch in the case in which the pouch film includes an inner layer and an outer layer each having a multilayer structure.

### DETAILED DESCRIPTION

Features of the disclosed technology disclosed in this patent document are described by example embodiments with reference to the accompanying drawings.

Hereinafter, example embodiments of the disclosed technology will be described with reference to various examples. However, the embodiments of the disclosed technology may be modified in various forms, and the scope of the disclosed technology is not limited to the embodiments described below.

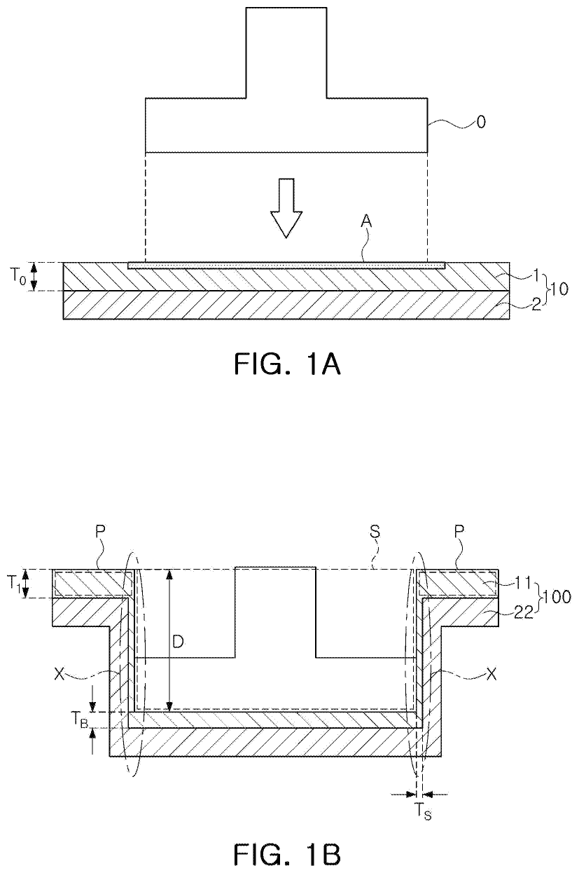

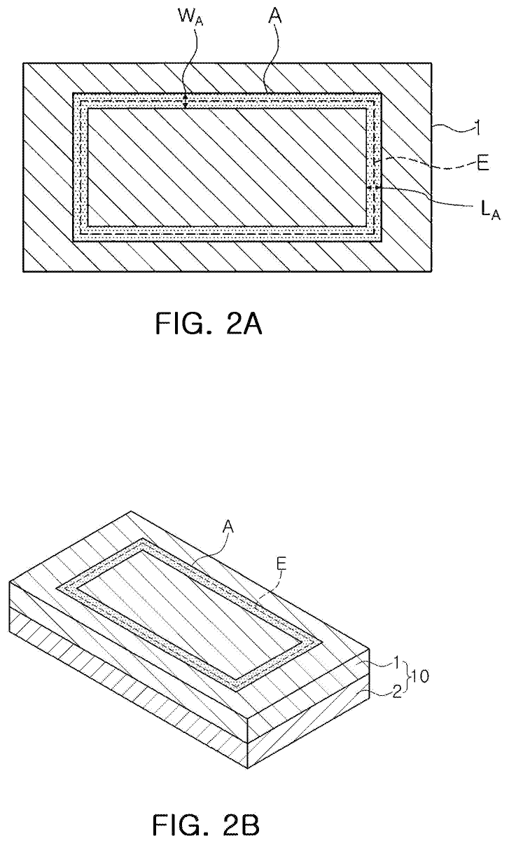

As described above, according to the existing method of manufacturing a pouch by applying high temperature and high pressure, a problem of damage to the pouch film may occur, and accordingly, in the case in which the temperature and pressure are lowered, the productivity of pouch manufacturing may decrease. In detail, when pressure is applied on the inner layer 1 by the pressing device 0, the pouch film is stretched in the direction of pressure (see FIGS. 1A and 1B), and accordingly, in the region near the ‘contact boundary (E) between the pressing device and the inner layer’ illustrated in FIGS. 2A and 2B, elongation is concentrated along with high temperature and high pressure, and damage and destruction may occur. Accordingly, the so-called ‘weak insulation portion (X),’ which is an area in which the thickness of a sealant layer 11 (corresponding to the inner layer (1) is excessively reduced, located on the side of an accommodating portion (S) of a finally manufactured pouch 100 for a secondary battery, may be formed, and as a result, the inner insulation of the pouch accommodating portion is deteriorated and corrosion may also occur (see FIG. 1B).

As described above, according to the existing method of manufacturing a pouch, it is difficult to suppress the influence of the weak insulation region (X), which is an area where there is concern about thickness reduction, insulation degradation, and occurrence of corrosion. In addition, in the case in which the temperature and pressure set in the pressing device (0) are lowered to prevent this problem, as described above, there is a problem in that the productivity of pouch manufacturing is lowered.

Accordingly, the inventors of the disclosed technology invented a method of manufacturing a pouch that may prevent the above problems, and proposes detailed embodiments below with reference to FIGS. 1A to 4B.

FIGS. 1A and 1B are conceptual views schematically illustrating, in sequence, an existing method of manufacturing a pouch in which an accommodating portion capable of accommodating an electrode assembly is formed by pressing a pouch film by a pressing device.

FIGS. 2A and 2B respectively are a plan view (FIG. 2A) and a perspective view (FIG. 2B) viewed from the top, conceptually illustrating the form in which area A is set on the inner layer of the pouch film, based on the boundary line where the inner layer contacts the pressing device.

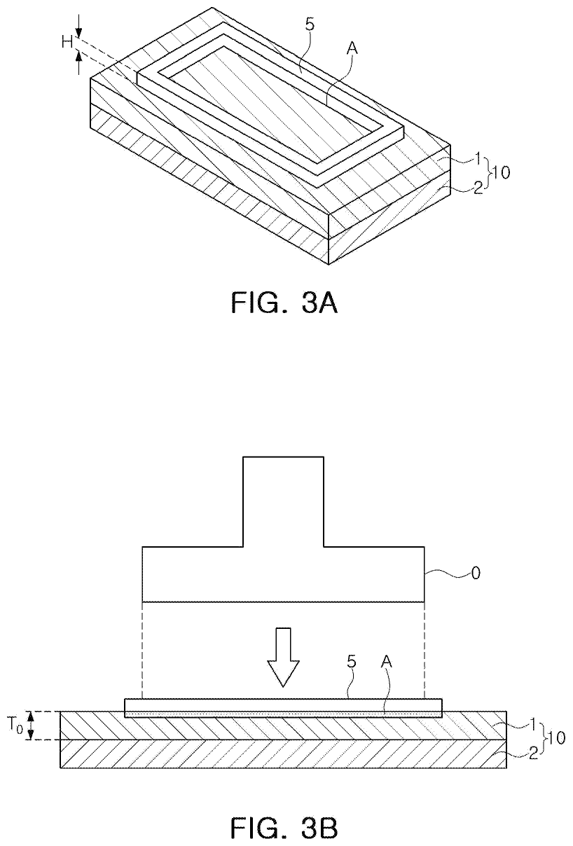

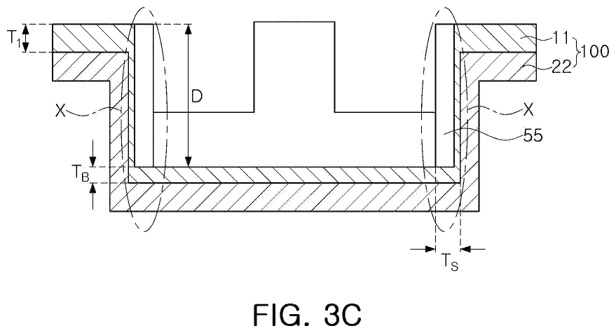

FIG. 3A is a perspective view conceptually illustrating a pouch film in which an inner reinforcing layer is formed on area A according to an embodiment.

FIGS. 3B and 3C are conceptual views schematically sequentially illustrating a method of manufacturing a pouch according to an embodiment, in which an accommodating portion with a reinforced weak insulation portion is formed by pressing a pouch film in which an inner reinforcing layer is formed on area A.

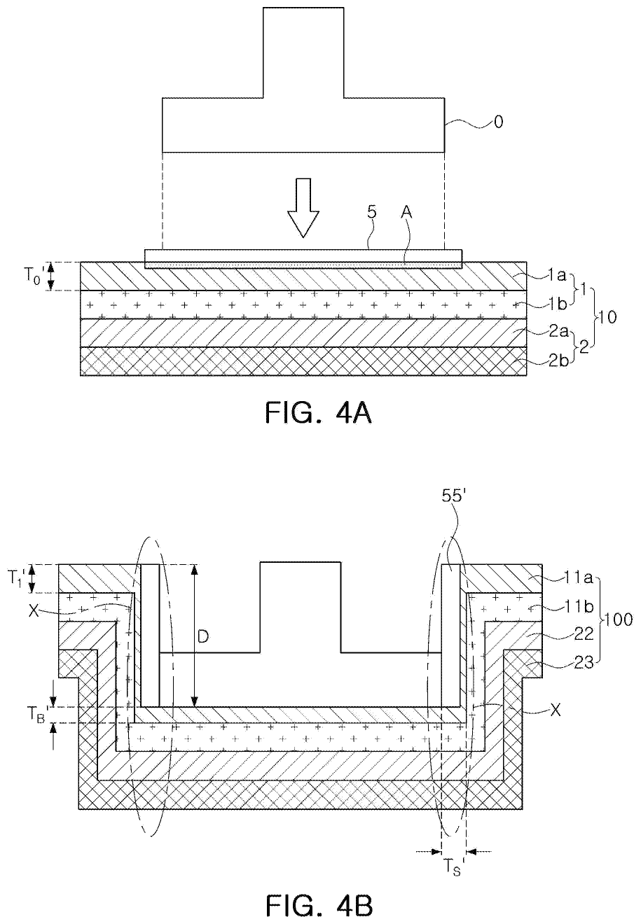

FIGS. 4A and 4B illustrate a method of manufacturing a pouch, in which an accommodating portion with a reinforced weak insulation portion is formed by pressing a pouch film having an inner reinforcing layer formed on area A according to an embodiment, and is a conceptual diagram of schematically illustrating, in order, a method of manufacturing a pouch in the case in which the pouch film includes an inner layer and an outer layer each having a multilayer structure.

Method of Manufacturing Pouch

As a method of manufacturing a pouch 100 for a secondary battery in which an accommodating portion (S) for accommodating an electrode assembly is formed in a pouch film 10 including an inner layer 1 and an outer layer 2; the method of manufacturing a pouch according to an embodiment includes forming an inner reinforcing layer 5 on one side of the inner layer 1; and stretching the pouch film 10 by pressing the inner layer 1 and the inner reinforcing layer 5. The inner reinforcing layer 5 includes at least one of the polymers included in the inner layer 1.

The inner layer (1) is a layer that comes into contact with the pressing device (0) when pressurized, and when manufactured in the form of a pouch, the inner layer (1) refers to a layer in direct contact with the electrode assembly and the electrolyte solution accommodated in the accommodating portion (S). In addition, the inner layer 1 is a layer corresponding to the sealant layer 11 in the finally manufactured pouch 100 for a secondary battery, and requires insulation and corrosion resistance because it is in direct contact with the electrode assembly and the electrolyte, and also requires sealability (i.e., excellent thermal bonding strength) capable of completely sealing the inside to block material transfer between the inside and outside.

Accordingly, the inner layer 1 and the sealant layer 11 may include at least one polymer selected from polyethylene, polypropylene, polycarbonate, polyethylene terephthalate, polyvinyl chloride, acrylic polymer, polyacrylonitrile, polyimide, polyamide, cellulose, aramid, nylon, polyester, polyparaphenylene benzobisoxazole, polyarylate, Teflon, and glass fiber. In detail, the polymer may be a polyolefin-based resin such as polypropylene (PP) or polyethylene (PE). In more detail, the polymer may be at least one selected from polypropylene (PP) and acid-modified polypropylene (PPa). The polypropylene (PP) has excellent mechanical properties such as tensile strength, stiffness, surface hardness, abrasion resistance, heat resistance, and excellent chemical properties such as corrosion resistance. Acid-modified polypropylene (PPa) is a polymer produced by acid-modified polypropylene (PP), and may facilitate the connection between metal and polymer to improve the adhesion between the inner and outer layers.

The inner layer 1 may have a multilayer structure. In detail, the inner layer 1 may include a second inner layer 1b and a first inner layer 1a positioned on the second inner layer (see FIG. 4A). In this case, the first inner layer 1a may include polypropylene (PP), and the second inner layer 1b may include acid-modified polypropylene (PPa). When the inner layer 1 has a multilayer structure and the polymer included in each layer is the above-mentioned type, the first inner layer 1a, which is in direct contact with the electrode assembly and the electrolyte, includes polypropylene (PP) to have excellent mechanical and chemical properties. The second inner layer 1b located below the first inner layer and in direct contact with the outer layer 2 includes acid-modified polypropylene (PPa) to improve adhesion between the first inner layer 1a and the outer layer 2.

The outer layer 2 is a layer that does not directly contact the pressing device 0 when pressurized, and refers to a layer that comes into contact with air or the like as a surface of an exterior material when manufactured in the form of a pouch. In addition, the outer layer 2 is a layer corresponding to a gas barrier layer 22 in the finally manufactured pouch 100 for secondary batteries, and is required to secure mechanical strength of the pouch, block external gas or moisture, and prevent leakage of electrolyte.

Accordingly, the outer layer 2 and the gas barrier layer 22 may include at least one metal selected from aluminum (Al), iron (Fe), carbon (C), chromium (Cr), manganese (Mn), nickel (Ni) and aluminum (Al). In detail, the metal may be aluminum (Al) excellent in mechanical strength and having excellent light weight, heat dissipation, and the like.

The outer layer 2 may have a multilayer structure. In detail, the outer layer 2 may include a second outer layer 2b and a first outer layer 2a disposed on the second outer layer (see FIG. 4A). In this case, the first outer layer 2a is a layer corresponding to the gas barrier layer 22 in the finally manufactured pouch 100 for a secondary battery and may include a metal such as aluminum (Al), and the second outer layer 2b is a layer corresponding to a surface protection layer 23 and may include a polymer. The surface protection layer 23 is located on the outermost layer and requires mechanical strength to protect the electrode assembly from external friction and collision, and also requires insulation to electrically insulate the electrode assembly externally.

Accordingly, the second outer layer 2b and the surface protection layer 23 may include at least one polymer selected from polyethylene, polypropylene, polycarbonate, polyethylene terephthalate (PET), polyvinyl chloride, acrylic polymer, polyacrylonitrile, polyimide, polyamide, cellulose, aramid, nylon, polyester, polyparaphenylene benzobisoxa Sol, polyarylate, teflon and fiberglass. In detail, the polymer may be at least one selected from nylon and polyethylene terephthalate (PET) having excellent wear resistance and heat resistance.

The second outer layer 2b and the surface protection layer 23 may also each have a multilayer structure, and as an example, may have a structure of stacking of a layer containing nylon and a layer containing polyethylene terephthalate (PET on one side of the nylon-containing layer.

The method of manufacturing a pouch includes forming the inner reinforcing layer 5 on one side of the inner layer 1; and stretching the pouch film 10 by pressing the inner layer 1 and the inner reinforcing layer 5. The inner reinforcing layer 5 includes at least one of polymers included in the inner layer 1.

The inner reinforcing layer 5 is a layer containing at least one of the polymers included in the inner layer 1, and may reinforce the area A and the weak insulating region X, which are parts that may be damaged by high temperature and high pressure when the pouch is manufactured by the pressing device 0. In detail, the inner reinforcing layer 5 may be formed on area A, which is a region in which elongation is concentrated in the inner layer when pressurized, and in this case, when pressurized, the area A may be protected from direct high temperature and high pressure, and may be stretched together to form a sealant layer reinforcing layer 55. Therefore, the weak insulation portion (X) of the sealant layer 11 is reinforced, such that insulation resistance characteristics may be maintained excellently without a large thickness decrease in most areas of the sealant layer, and the occurrence of corrosion and the like in the battery driving process may be reduced.

The inner reinforcing layer 5 includes at least one of polymers included in the inner layer 1. In detail, the inner reinforcing layer 5 may have substantially the same composition as the composition of the inner layer 1. In this case, the sealant layer 11 and the sealant layer reinforcing layer 55 formed by pressing the inner layer 1 and the inner reinforcing layer 5 have the same composition and may not be substantially distinguished in the final manufactured pouch. A detailed description of the polymer is omitted because it overlaps with the above description.

The inner reinforcing layer may be formed on the area A where elongation is concentrated in the inner layer when pressurized. In detail, the area A is an area where stretching is concentrated when pressing for stretching the pouch film, and may be a certain area including a boundary line where the inner layer of the pouch film comes into contact with the pressing device. The inventors of the disclosed technology have confirmed that the occurrence of problems such as damage to the inner layer due to pressurization may be alleviated when the inner reinforcing layer is formed on the area A, set in consideration of the boundary line where the inner layer comes into contact with the pressing device. Hereinafter, the area A will be described in detail.

The W_{A} is the width of the area A, and refers to the sum of inner and outer distances vertically spaced based on the boundary line where the length of the pressing device comes into contact with the inner layer. In addition, the L_{A} is the length of the area A, and refers to the sum of inner and outer distances spaced apart in a vertical direction based on the boundary line where the width portion of the pressing device comes into contact with the inner layer. In this case, the ‘length portion’ of the pressing device refers to the length of the relatively long side on the surface of the rectangular shape on which the pressing device and the inner layer come into contact, and the ‘width portion’ thereof refers to the length of the relatively short side. In the case in which the shape of the surface where the pressing device and the inner layer come into contact is a square, the ‘width portion’ and the ‘length portion’ of the pressing device may be substantially the same portion without distinction. In addition, the ‘inner and outer distances’ respectively refer to the distances spaced from the boundary line, with the direction toward the center of the inner layer 1 being inward and the direction away from the center being outward, based on the boundary line (E).

The W_{A} and L_{A} may be 0.01 to 10 cm, respectively. In detail, the W_{A} and L_{A} may be 0.1 to 5 cm, respectively, and may be 0.5 to 2 cm.

When the W_{A} and L_{A} values, etc. are within the above range, the area A may be appropriately set in consideration of the width and length of the electrode, battery design, and the like, and the internal reinforcing layer 5 for reinforcing the area where high temperature and high pressure are applied to concentrate the stretching may be formed in an appropriate amount on an appropriate area, thereby significantly increasing efficiency and productivity.

The forming of the inner reinforcing layer 5 may be performed by setting a maximum height of the inner reinforcing layer to the forming depth D, to 0.01 to 1 mm/cm. In detail, the operation of forming the inner reinforcing layer 5 may be performed by setting the maximum height of the inner reinforcing layer to the forming depth (D) to 0.05 to 0.5 mm/cm, or to 0.07 to 0.2 mm/cm.

The forming depth (D) refers to the depth formed by the pressing device 0 when pressing the pouch film 10 (see FIG. 1B), and corresponds to the height of the accommodating portion (S) for accommodating the electrode assembly in the pouch 100 for secondary batteries. As the forming depth (D) deepens, a larger electrode assembly may be accommodated, and thus the energy density of the secondary battery may be further improved. However, the extent to which the pouch film 10 is stretched is also greatly required and the thickness of the weak insulation portion (X) becomes thinner, and as a result, it may be difficult to maintain excellent insulation characteristics of the sealant layer 11 or the like.

Considering this point, when the amount of the inner reinforcing layer 5 formed according to the depth degree of the forming depth D is appropriately increased, further thinning of the insulation weak area (X) as the forming depth (D) deepens may be alleviated, and high energy density and insulation characteristics of secondary batteries may be secured at an excellent level at the same time. Therefore, when the operation of forming the inner reinforcing layer 5 is performed with the maximum height of the inner reinforcing layer relative to the forming depth D within the above range, the high energy density and insulation characteristics of the secondary battery at an excellent level may be secured at the same time.

In the operation of forming the inner reinforcing layer 5, the inner reinforcing layer may be formed by coating, spraying, and the like, and the formation method is not particularly limited as long as the effect of the disclosed technology may be obtained.

The shape of the inner reinforcing layer 5 may be an angular rectangular parallelepiped shape as illustrated in FIG. 3A, and may have a random shape in which the height H of the inner reinforcing layer or the like is not constant, depending on the formation method (not illustrated). For example, the shape of the inner reinforcing layer 5 formed is not particularly limited as long as the effect of the disclosed technology may be obtained.

The operations of forming the inner reinforcing layer (5) and stretching the pouch film 10 may be performed as a separate operation in the described order, but as long as the effect of the disclosed technology may be obtained, the above process may also be performed substantially simultaneously.

Stretching the pouch film 10 may be performed at 60 to 150° C. In detail, the stretching of the pouch film 10 may be performed at 80 to 120° C.

The pressure of the pressing device 0 applied in the operation of stretching the pouch film 10 may be 100 to 500 kPa. In detail, the pressure of the pressing device 0 applied in the operation of stretching the pouch film 10 may be 200 to 400 kPa.

When the stretching process by pressurization proceeds within the above-mentioned temperature and pressure ranges, polymers such as polyethylene terephthalate (PET) included in the outer layer 2 may be stretched efficiently in a short period of time without fear of being damaged, and the pouch manufacturing process time by pressurization may be shortened.

In the method of manufacturing a pouch, an R_{S} value according to Equation 1-1 below may be 50% or more. In detail, the R_{S} value may be 55% or more, 100% or less, or 70% or less.

R_{S}=T_{S_MIN}/T₀×100 [Equation 1-1]

In Equation 1-1, R_{S} is a side thickness retention rate (%), T_{S_MIN} is a minimum value of the sealant layer thickness (T_{S}) located on the side of the accommodating portion, and T₀ is a thickness of the inner layer.

When the inner layer 1 and the sealant layer 11 have a multilayer structure (see FIGS. 4A and 4B), the side thickness retention ratio R_{S}′ may be calculated according to Equation 1-2 below, and the R_{S}′ value may be 50% or more. In detail, the R_{S}′ value may be 50% or more, 55% or more, 100% or less, or 70% or less.

R_{S}′=T_{S_MIN}′/T₀′×100 [Equation 1-2]

In Equation 1-2, R_{S}′ is the side thickness retention rate (%), T_{S_MIN}′ is the minimum value of the first sealant layer thickness (T_{S}′) located on the side of the accommodating portion, and T₀′ is the thickness of the first inner layer.

When the R_{S} value is within the above range, in the manufactured pouch 100 for a secondary battery, the minimum thickness (T_{S}) of the sealant layer located on the side of the accommodating portion may be maintained without a relatively large difference compared to the thickness (T₀) of the inner layer before the pouch film 10 is stretched. Accordingly, the weak insulation portion (X) of the pouch 100 for a secondary battery is reinforced such that the thickness thereof is well maintained, and the insulation resistance characteristics of the pouch may also be excellent.

Pouch for Secondary Battery

The pouch 100 for a secondary battery according to an embodiment includes an accommodating portion (S) in which an electrode assembly is accommodated; and a sealing portion (P), and the pouch for secondary batteries includes a sealant layer 11 and a gas barrier layer 12. A minimum insulation resistance value of the sealant layer on the side of the accommodating portion is 100 MΩ or more.

A detailed description of the accommodating portion (S) is omitted because it overlaps with the above description, and the sealing portion (P) refers to a part that is finally sealed after receiving the electrode assembly in the accommodating portion (S) and then injecting the electrolyte solution (see FIG. 1B).

The minimum insulation resistance value of the sealant layer on the side of the accommodating portion may be 200 MΩ or more, 500 MΩ or more, 5000 MΩ or less, or 1000 MΩ or less.

In the pouch 100 for a secondary battery, the sealant layer reinforcing layer 55 is formed on the sealant layer on the side of the accommodating portion S due to the inner reinforcing layer 5 formed on the inner layer 1 during the manufacturing process to prevent damage, and insulation resistance characteristics may be excellent by uniformly maintained thickness for each region. In general, in the case of a portion where the thickness of the sealant layer 11 is excessively reduced in the weak insulation portion (X) due to damage to the inner layer 1 during the pouch manufacturing process, the insulation resistance value is lowered to 1 MΩ or less, and the insulation properties may be significantly deteriorated. On the other hand, in the case of the sealant layer located on the side of the accommodating portion of the pouch for a secondary battery, the ‘minimum insulation resistance value’, which is the insulation resistance value of the part where the insulation properties are the most deteriorated due to a significant reduction in thickness due to damage or destruction, etc. is maintained as high as 100 MΩ or more. Therefore, the insulation properties in the final manufactured pouch may be excellent in all areas.

The pouch 100 for a secondary battery may have an R_{SS} value of 0.5 or more according to Equation 2-1 below. In detail, the R_{SS} value may be greater than or equal to 0.55, less than or equal to 1, and less than or equal to 0.7.

R_{SS}=T_{S_MIN}/T_{1_MAX} [Equation 2-1]

In Equation 2-1 above, R_{SS} is the thickness ratio of the sealant layer located on the side of the accommodating portion and the sealing portion, T_{S_MIN} is the minimum value of the sealant layer thickness (T_{S}) located on the side of the accommodating portion, and T_{1_MAX} is the maximum value of the sealant layer thickness (Tₗ) located on the sealing portion.

When the R_{SS} value is within the above range, the difference between the thickness (T_{S}) of the sealant layer located on the side of the accommodating portion and the thickness (Tₗ) of the sealant layer located on the sealing portion may be prevented from becoming excessively increasing, and therefore, the insulating properties of the sealant layer may be maintained excellently in most areas.

When the inner layer 1 and the sealant layer 11 have a multilayer structure (see FIGS. 4A and 4B), the thickness ratio (R_{SS}′) of the first sealant layer located on the side of the accommodating portion and the sealing portion may be calculated according to Equation 2-2 below, and the R_{SS}′ value may be 0.5 or more, 0.55 or more, 1 or less, or 0.7 or less.

R_{SS}′=T_{S_MIN}′/T_{1_MAX}′ [Equation 2-2]

In Equation 2-2 above, R_{SS}′ is the thickness ratio of the first sealant layer located on the side surface of the accommodating portion and the sealing portion, T_{S_MIN}′ is the minimum value of the thickness (T_{S}′) of the first sealant layer located on the side surface of the accommodating portion, and T_{1_MAX}′ is the maximum value of the first sealant layer thickness (Tₗ′) located on the sealing portion.

The pouch 100 for a secondary battery may have an R_{SB} value of 0.5 to 1.5 according to Equation 3-1 below. The R_{SB} value may be 0.6 to 1.0, and may be 0.7 to 0.9.

R_{SB}=T_{S_MIN}/T_{B_MIN} [Equation 3-1]

In Equation 3-1 above, R_{SB} is the thickness ratio of the sealant layer located on the side surface and the bottom surface of the accommodating portion, T_{S_MIN} is the minimum value of the sealant layer thickness (T_{S}) located on the side surface of the accommodating portion, and T_{B_MIN} is the minimum value of the sealant layer thickness (T_{B}) located on the bottom surface of the accommodating portion.

When the R_{SB} value is within the above-described range, the thickness of the sealant layer positioned on the side surface and the bottom surface of the accommodating portion is maintained without a significant difference, such that the insulating properties of the side surface and the bottom surface of the sealant layer may be all secured at excellent levels.

When the inner layer 1 and the sealant layer 11 have a multilayer structure (see FIGS. 4A and 4B), the thickness ratio (R_{SB}′) of the first sealant layer positioned on the side surface and bottom surface of the accommodating portion may be calculated according to the following equation 3-2, and the R_{SB}′ value may be 0.5 to 1.5, 0.6 to 1.0, and 0.7 to 0.9.

R_{SB}′=T_{S_MIN}′/T_{B_MIN}′ [Equation 3-2]

In Equation 3-2 above, R_{SB}′ is the thickness ratio of the first sealant layer located on the side surface and the bottom surface of the accommodating portion, T_{S_MIN} is the minimum value of the first sealant layer thickness (T_{S}′) located on the side surface of the accommodating portion, and T_{B_MIN} is the minimum value of the sealant layer thickness (T_{B}′) located on the bottom of the accommodating portion.

The pouch 100 for a secondary battery may be manufactured by the method of manufacturing a pouch described above. In detail, the pouch 100 for a secondary battery may be manufactured by a method of manufacturing a pouch for a secondary battery, in which an accommodating portion S for accommodating an electrode assembly is formed in a pouch film 10 including an inner layer 1 and an outer layer 2. The method of manufacturing a pouch may include forming an inner reinforcing layer 5 on one surface of the inner layer 1; and stretching the pouch film 10 by pressing the inner layer 1 and the inner reinforcing layer 5. The inner reinforcing layer 5 may include at least one of polymers included in the inner layer 1. When the pouch 100 for a secondary battery is manufactured by the pouch manufacturing method above, a specific part (area A) of the inner layer 1, which is a part where stretching is concentrated and where damage may occur during the manufacturing process, is reinforced. Therefore, in the manufacture pouch, the thickness of the weak insulation area (X) and the like may be maintained excellently, and accordingly, the insulation characteristics may be secured at an excellent level in all areas.

Pouch-Type Secondary Battery

A pouch-type secondary battery according to an embodiment includes the pouch 100 for secondary batteries described above, and the pouch for secondary batteries includes an electrode assembly (not illustrated) in the accommodating portion S.

The electrode assembly may include a positive electrode, a negative electrode, and a separator interposed between the positive electrode and the negative electrode. The structure of the electrode assembly is not particularly limited, but may be a jelly roll-type structure in which a separator is interposed between long sheet-type positive electrode and negative electrode coated with an active material and wound; a stacked structure in which unit cells including a positive electrode, a negative electrode, and a separator interposed therebetween are sequentially stacked; a stack-folding structure in which the unit cells of the stacked structure are wound by a separate separator; or a lamination-stack type structure in which unit cells of the stack type structure are stacked with a separator interposed therebetween and are attached to each other.

On the other hand, the positive electrode may include, as an active material, lithium-transition metal oxides such as lithium cobalt oxide (LiCoO₂), lithium manganese oxide (LiMn₂O₄), lithium nickel oxide (LiNiO₂), or lithium-transition metal composite oxides in which some of these transition metals are substituted with other transition metals. In detail, the positive electrode may include, as the active material, at least one selected from lithium-nickel-manganese oxide (LNMO) that does not contain cobalt (Co) and is represented by a chemical formula of LiNiₓMn₂₋ₓO₄ (0<x<1) or the like; lithium-permanganese oxide (LMR) that does not contain nickel (Ni) and is represented by a formula of Li₁₊ₓMn₂₋ₓO₄ (0<x<0.1) or the like; nickel-chromium-manganese oxide (NCM) represented by a chemical formula of LiₓNiₐCo_{b}Mn_{c}O_{y} (0<x≤1.1, 2≤y≤2.02, 0<a<1, 0<b<1, 0<c<1, 0<a+b+c≤1) or the like; and lithium-phosphate-iron oxide (LFP) represented by a chemical formula of LiFePO₄ or the like.

The negative electrode may include, as an active material, at least one selected from carbon-based materials such as natural graphite and artificial graphite; silicon-based materials such as SiOₓ (0<x<2), Si—C, and the like; at least one metal selected from Li, Sn, Zn, Mg, Cd, Ce, Ni, and Fe; alloys composed of the above metals; oxides of the above metals; and a composite of the above metal and carbon.

When the pouch-type secondary battery includes the pouch 100 for a secondary battery described above, a pouch-type secondary battery that has excellent insulation properties and is free from corrosion during the battery driving process may be provided.

### Example

Hereinafter, the disclosed technology will be described in more detail with reference to examples. The following examples are intended to describe the disclosed technology in more detail, and the disclosed technology is not limited thereby.

### 1. Manufacturing Pouches for Secondary Batteries

### (1) Example

A multilayer pouch film including a polypropylene (PP) layer (thickness: 40 μm) as the first inner layer, an acid-modified polypropylene (PPa) layer (thickness: 40 μm) as the second inner layer, and an aluminum (Al) layer (thickness: 40 μm) as the outer layer, was cut into a size of 400 cm×400 cm, to form a sample which was applied as the pouch film of the example. In addition, in the process of manufacturing a pouch for a secondary battery, the inner and outer distances are set to 0.5 cm based on the boundary line (E) where the first inner layer (PP layer) of the pouch film contacts the pressing device, and thus, the area A with the width (W_{A}) and length (L_{A}) values of respectively 1 cm was set. Thereafter, the maximum height of the inner reinforcing layer relative to the forming depth (D) was set to 0.1 mm/cm, and the inner reinforcing layer containing polypropylene (PP) was formed on the area A through spraying and coating. According to the set forming depth, the pouch film was pressed and stretched at a pressure of 200 to 400 kPa at 80 to 120° C. by a pressing device to prepare a pouch for a secondary battery including an accommodating portion according to an embodiment.

### (2) Comparative Example

A pouch for a secondary battery of the Comparative Example was manufactured in the same manner as the pouch for a secondary battery of the above embodiment, except for not forming an inner reinforcing layer.

### 2. Evaluation of Pouch for Secondary Battery

### (1) Side Thickness Retention Rate (R_{S}′)

The thickness (T₀′) of the polypropylene (PP) layer as the first inner layer; and the thickness (T_{S}′) of the first sealant layer located on the side of the accommodating portion of the pouch for a secondary battery manufactured in Examples and Comparative Examples were measured for the respective Example and Comparative Example, and the results of calculating the side thickness retention ratio (R_{S}′) according to Equation 1-2 are illustrated in Table 1 below.

R_{S}′=T_{S_MIN}′/T₀′×100 [Equation 1-2]

In Equation 1-2, R_{S}′ is the side thickness retention rate (%), T_{S_MIN}′ is the minimum value of the first sealant layer thickness (T_{S}′) located on the side of the accommodating portion, and T₀′ is the thickness of the first inner layer.

TABLE 1

| | First | First sealant | Side |
|---|---|---|---|
| | Inner | layer thickness | thickness |
| | Layer | (T_{S}′ ) on Side of | retention |
| | Thickness | Accommodating | ratio |
| | (T₀′ ) | Portion | (R_{S}′ ) |
| Example | 40 μm | 24 to 40 μm | 60% |
| Comparative | 40 μm | 0 to 12 μm | 0% |
| Example | | | |

### (2) Thickness Ratio (R_{SS}′) of Side of the Accommodating Portion and Sealing Portion

The maximum thickness (Tₗ′) of the first sealant layer located on the sealing portion of the pouch for a secondary battery, manufactured in examples and comparative examples, was measured, and by the thickness (T_{S}′) value of the first sealant layer on the side of the accommodating portion, measured above, the results of calculating the thickness ratio (R_{SS}′) of the side of the accommodating portion and the sealing portion according to Equation 2-2 below are illustrated in Table 2 below.

R_{SS}′=T_{S_MIN}′/T_{1_MAX}′ [Equation 2-2]

In Equation 2-2 above, R_{SS}′ is the thickness ratio of the first sealant layer located on the side surface of the accommodating portion and the sealing portion, T_{S_MIN}′ is the minimum value of the first sealant layer thickness (T_{S}′) located on the side surface of the accommodating portion, and T_{1_MAX}′ is the maximum value of the first sealant layer thickness (Tₗ′) located on the sealing portion.

TABLE 2

| | | First sealant layer | |
|---|---|---|---|
| | Maximum | thickness (T_{S}′) on | Thickness |
| | thickness ( T₁_{_{—}}_{MAX}′) | Side of | Ratio (R_{SS}′) |
| | of First Sealant Layer | Accommodating | of side/sealing |
| | on Sealing Portion | Portion | portion |
| Example | 40 μm | 24 to 40 μm | 0.6 |
| Comparative | 40 μm | 0 to 12 μm | 0 |
| Example | | | |

### (3) Side and Bottom Thickness Ratio (R_{SB}′) of Accommodating Portion

The thickness (T_{B}′) of the first sealant layer located on the bottom surface of the accommodating portion of the pouch for a secondary battery, manufactured in examples and comparative examples, was respectively measured, and by the result thereof and the thickness (T_{S}′) value of the first sealant layer on the side of the accommodating portion measured above, the side and bottom thickness ratio R_{SB}′ of the first sealant layer is calculated according to the following equation 3-2, and the calculation results are illustrated in Table 3 below.

R_{SB}′=T_{S_MIN}′/T_{B_MIN}′ [Equation 3-2]

In Equation 3-2, R_{SB}′ is the thickness ratio of the first sealant layer located on the side surface and the bottom surface of the accommodating portion, T_{S_MIN} is the minimum value of the first sealant layer thickness (T_{S}′) located on the side surface of the accommodating portion, and T_{B_MIN} is the minimum value of the sealant layer thickness (T_{B}′) located on the bottom of the accommodating portion.

### (4) Insulation Characteristics and Corrosion

An electrode assembly including a positive electrode (NCM622), a separator (PP fabric) and a negative electrode (artificial graphite), and an electrolyte solution (LiPF6 1M electrolyte solution), were filled in a pouch for a secondary battery according to Example and Comparative Example, and then, the pouch was sealed and stored at 60° C. for 4 weeks. Then, a voltage of 50V 1.5 s was applied to the aluminum (Al) layer and the insulation resistance value was measured using Hi-pot equipment, and the minimum value is illustrated in Table 3 below. In addition, the occurrence of corrosion near the side of the accommodating portion was evaluated by O and X, and the results are illustrated in Table 3 below. At this time, whether or not corrosion occurred was evaluated by visually determining whether black spots were formed near the side of the accommodating portion.

TABLE 3

| | First sealant | | | |
|---|---|---|---|---|
| | layer | Side/ | | |
| | thickness | Bottom | | |
| | (T_{B}′) on | Thick- | | |
| | Bottom of | ness | Minimum | |
| | Accommodating | ratio | Insulation | Corrosion |
| | Portion | (R_{SB}′ ) | Resistance | Occurrence |
| Example | 30 to 40 μm | 0.8 | 100 MΩ or | X |
| | | | more | |
| Comparative | 30 to 40 μm | 0 | 1 MΩ or less | ◯ |
| Example | | | | |

Referring to Tables 1 to 3, in the case of the pouch for a secondary battery of the embodiment to which the pouch film having the inner reinforcing layer is applied, the thickness of the sealant layer located on the side of the accommodating portion was relatively large, as compared to the pouch for a secondary battery of the comparative example, and accordingly, the side thickness retention ratio (R_{S}), and the thickness ratio (R_{SS}) of the side of the accommodating portion and the sealing portion were also high. In addition, the minimum thickness ratio of the sealant layer located on the bottom surface of the accommodating portion and the sealant layer located on the side thereof in the manufactured pouch for a secondary battery was also found to have a higher value in the Example than in the Comparative Example. Considering this, when forming an inner reinforcing layer on the pouch film before stretching as in the embodiment, it is judged that the thickness of the weak insulation portion (X), where the stretching is concentrated and the thickness becomes thin during the stretching process according to pressurization, may be maintained at a relatively high value.

In addition, in the case of an embodiment in which the thickness of the weak insulation portion (X) of the pouch for a secondary battery manufactured by forming the inner reinforcing layer as above, there was no damage to the weak insulation portion (X), and thus, the minimum insulation resistance value was much higher than that of the comparative example. Unlike the comparative example, it was found that corrosion also did not occur. Considering this, in the case of a pouch for a secondary battery in which the weak insulation portion (X) is reinforced by the formation of an inner reinforcing layer as in the embodiment, it is judged that the insulation resistance characteristics are excellently maintained and the occurrence of corrosion during the battery driving process may be substantially alleviated.

As set forth above, according to an embodiment, there is provided a method of manufacturing a pouch, in which the damage of a pouch film is alleviated and the thickness of the layer inside a finally manufactured pouch is maintained excellent as a whole.

According to an embodiment, a method of manufacturing a pouch, in which a pouch may be manufactured in a relatively short period of time by applying high temperature and high pressure and may be manufactured with excellent yield without reducing productivity, is provided.

According to an embodiment, a pouch for a secondary battery, in which an insulation resistance value of a accommodating portion accommodating an electrode assembly is excellent in substantially all areas to have improved insulation characteristics and corrosion is mitigated during a battery driving process, and a pouch-type secondary battery having the same, are provided.

Only specific examples of implementations of certain embodiments are described. Variations, improvements and enhancements of the disclosed embodiments and other embodiments may be made based on the disclosure of this patent document.

What is claimed is:

1. A method of manufacturing a pouch for a secondary battery, in which an accommodating portion for accommodating an electrode assembly is formed in a pouch film including an inner layer and an outer layer, the method comprising:
forming an inner reinforcing layer on one surface of the inner layer; and
stretching the pouch film by pressing the inner layer and the inner reinforcing layer,
wherein the inner reinforcing layer includes at least one of polymers included in the inner layer.

2. The method of claim 1, wherein the polymer is at least one selected from polypropylene (PP) and acid-modified polypropylene (PPa).

3. The method of claim 1, wherein the inner reinforcing layer is formed on area A,
wherein the area A is an area including a boundary line where the inner layer comes into contact with a pressing device.

4. The method of claim 3, wherein a width (W_{A}) of the area A is a sum of inner and outer distances vertically spaced based on a boundary line where a length portion of the pressing device comes into contact with the inner layer,
wherein a value of the W_{A} is 0.01 to 10 cm.

5. The method of claim 3, wherein a length (L_{A}) of the area A is a sum of inner and outer distances spaced in a vertical direction based on a boundary line where a width portion of the pressing device comes into contact with the inner layer,
wherein a value of the L_{A} is 0.01 to 10 cm.

6. The method of claim 1, wherein the forming of the inner reinforcing layer is performed with a maximum height of the inner reinforcing layer of 0.01 to 1 mm/cm relative to a forming depth.

7. The method of claim 1, wherein the stretching of the pouch film is performed at 60 to 150° C.

8. The method of claim 1, wherein the pouch for a secondary battery includes a sealant layer and a gas barrier layer, and
an R_{S} value according to Equation 1-1: R_{S}=T_{S_MIN}/T₀×100 is 50% or more, where R_{S} is a side thickness retention rate (%), T_{S_MIN} is a minimum value of a sealant layer thickness (T_{S}) located on a side of the accommodating portion, and T₀ is the thickness of the inner layer.

9. A pouch for a secondary battery, including an accommodating portion accommodating an electrode assembly therein, and a sealing portion, the pouch comprising:
a sealant layer and a gas barrier layer,
wherein a minimum insulation resistance value of the sealant layer on a side of the accommodating portion is 100 MΩ or more.

10. The pouch for a secondary battery of claim 9, wherein an R_{SS} value according to Equation 2-1: R_{SS}=T_{S_MIN}/T_{1_MAX} is 0.5 or more,
where R_{SS} is a thickness ratio of the sealant layer located on the side of the accommodating portion and the sealing portion, T_{S_MIN} is a minimum value of a sealant layer thickness (T_{S}) located on the side of the accommodating portion, and T_{1_MAX} is a maximum value of a sealant layer thickness (Tₗ) located on the sealing portion.

11. The pouch for a secondary battery of claim 9, wherein an R_{SB} value according to Equation 3-1: R_{SB}=T_{S_MIN}/T_{B_MIN} is 0.5 to 1.5,
where R_{SB} is a thickness ratio of the sealant layer located on the side and a bottom surface of the accommodating portion, T_{S_MIN} is a minimum value of the thickness of the sealant layer located on the side surface of the accommodating portion, and T_{B_MIN} is a minimum value of the thickness of the sealant layer located on the bottom surface of the accommodating portion.

12. A pouch for a secondary battery, including an accommodating portion accommodating an electrode assembly therein, and a sealing portion, the pouch comprising:
a sealant layer and a gas barrier layer,
wherein a minimum insulation resistance value of the sealant layer on a side of the accommodating portion is 100 MΩ or more,
wherein the pouch for a secondary battery is manufactured by the method of manufacturing a pouch according to claim 1.

13. A pouch-type secondary battery comprising:
the pouch for a secondary battery according to claim 9,
wherein the pouch for a secondary battery includes an electrode assembly in an accommodating portion,
wherein the electrode assembly includes a positive electrode, a negative electrode, and a separator interposed therebetween.

14. The pouch-type secondary battery of claim 13, wherein the electrode assembly has a jelly roll structure, a stack structure, a stack-folding structure, or a lamination-stack structure.

15. The pouch-type secondary battery of claim 13, wherein the positive electrode includes at least one selected from lithium-nickel-manganese oxide (LNMO), lithium-permanganese oxide (LMR), nickel-chromium-manganese oxide (NCM), and lithium-phosphate-iron oxide (LFP), as an active material.

16. The pouch-type secondary battery of claim 13, wherein the negative electrode includes at least one selected from a carbon-based material, a silicon-based material, at least one metal selected from Li, Sn, Zn, Mg, Cd, Ce, Ni and Fe, an alloy composed of the metal, an oxide of the metal, and a composite of the metal and carbon, as an active material.
